(19) United States
(12) Patent Application Publication
(10) Pub. No.: US 2003/0010429 A1
(43) Pub. Date: Jan. 16, 2003

(54) Applique transfer system

(76) Inventor: Edward Serra, SR., Sun Valley, CA (US)

Correspondence Address: ROBERT J. SCHAAP, 21241 Ventura Boulevard, Suite 188, Woodland Hills, CA, 91364, US

(21) Appl. No.: 10/155,312

(22) Filed: May 24, 2002

Related U.S. Application Data
(60) Provisional application No. 60/293,428, filed on May 25, 2001.

(51) Int. Cl. B32B 35/00

(52) U.S. Cl. 156/230

(57) ABSTRACT

An applique transfer system for permanently transferring to a substrate, such as a metal or plastic substrate, an applique from a foil. The applique may be in the form of a thin preprinted or other prepared foil having either a color or holographic marking or other design or markings thereon. This design or markings is then transferred onto a substrate. In order to achieve easy transfer of the applique to a substrate, it may be necessary, in many cases, and at least desirable in other cases, to apply a coating, such as an acrylic-urethane coating, to the substrate. After the coating has bonded, an applique is transferred to the coating on the substrate, through appropriate transfer techniques, such as heat transfer, or cold foil transfer techniques, using contact pressure. The applique typically will adhere only in the areas of the coating and, hence, problems of marginal registration of the applique and the coating are avoided.

### BACKGROUND OF THE INVENTION

1. Field of the Invention

This invention relates in general to certain new and useful improvements in a transfer apparatus and process for applying a foil applique to a substrate, and more particularly, to a transfer process and apparatus of the type stated, which allows for a tightly adherent and relatively durable foil transfer on a substrate.

2. Brief Description of Related Art

The application of a foil applique to a substrate for decorative or feature enhancing purposes is well known, and has been practiced for many years. Indeed, the application of an applique, such as a message or a design, or both, is commonly employed with many articles. Usually, the articles to which the applique is applied are relatively porous, to allow the applique to adhere to the surface of the article. In addition, the applique must be carefully chosen to be compatible with the surface contour and surface features of that particular article.

The effectiveness of applying an applique to an article depends largely upon the surface characteristics of the article, the composition of the article, the type of applique which is used, and indeed, the application process. In fact, much trial and error testing of the various factors is required in order to achieve a suitable foil applique transfer. In the foil applique transfer systems, the applique is contained on a foil, such as a metal or plastic foil, which is relatively thin and flexible. The applique is then brought into contact with the surface of the article to which the applique is to be applied, and when using heat or pressure, or both, the applique is then transferred directly to the surface of the article.

The resulting applique frequently is not tightly adherent to the article, and in many cases, is subject to scratching or edge damage which mars the overall appearance of the applique, and for that matter, could ruin the article, or at least the value of the article, to which the applique is applied. Generally, it has been found to be relatively ineffective to apply a foil applique to a nonporous material, such as a glass or ceramic or a metal surface. Foil appliques are also relatively ineffective for application to many natural stones. Hence, it would be desirable to apply an applique to other materials not presently adapted to receive an applique, but the effectiveness of the application process is limited.

Due to the fact that the foil applique cannot be applied to numerous materials, other means of applying a design to a substrate must be employed, as for example, printing or the like. However, these techniques also limit the effectiveness and the appearance of the foil applique. Moreover, and in recent years, there has been an interest in applying an applique to nonporous substrates. Also, there has been increased interest in applying appliques which are of a holographic form. The printing of a holographic image is a very complex, tedious and costly process. Hence, there is presently no effective technique of applying a foil applique to a nonporous substrate.

In recent years, certain governments have expressed an interest in applying an applique to the currency coins of that government. As a simple example, the Canadian government is experimenting with a process and an apparatus for applying a holographic applique to the currency coins of Canada. The system envisioned by the Canadian government, as well as others who are attempting to apply holographic foil transfers, is necessarily quite expensive and very involved. Moreover, there is a high article rejection rate with the currently available processes and apparatus.

Hot stamping is also a process for applying a design or other information to a surface of an article. However, and here again, hot stamping is limited, again, depending upon the materials to which the stamping is to be applied, and moreover, the size of the article. Hot stamping, for example, is not effective with a small sized article, such as a currency coin.

Moreover, there is presently no effective process for applying a foil applique to numerous material surfaces, such as ceramic surfaces and metal surfaces. The same holds true with flexible surfaces, as for example, leather materials, several plastic materials, and the like. It would therefore be desirable to provide both an apparatus and a method for applying a foil applique to a substrate in a tightly adherent manner, and which can withstand abuse without marring or otherwise damaging the foil applique.

### OBJECTS OF THE INVENTION

It is, therefore, one of the primary objects of the present invention to provide a process for applying a foil applique to a substrate, in such manner that the process is relatively effective in achieving a tightly adherent applique on a wide variety of substrates.

It is another object of the present invention to provide a process for applying a foil transfer applique to a substrate, and where the applique is tightly adherent to the substrate, and is capable of withstanding normal abuse and handling which would otherwise damage foil appliques applied by prior art techniques.

It is a further object of the present invention to provide a process for applying to a substrate a foil applique of the type stated, which can be operable with a heat transfer technique or a cold applique.

It is an additional object of the present invention to provide a process for applying a holographic foil applique to a substrate, such that the applique renders a holographic image on that article, and which applique is also tightly adherent and not subject to damage by normal handling.

It is still another object of the present invention to provide a process for applying a foil applique to a substrate, which relies upon the initial application of a coating to that substrate followed by the application of the foil applique to the coating.

It is another salient object of the present invention to provide an apparatus for applying an applique by a transfer process to a substrate, and which apparatus allows for a tightly adherent and abuse withstanding applique, on that substrate.

With the above and other objects in view, my invention resides in the novel features, form, construction, arrangement, and combination of parts presently described and pointed out in the claims.

### BRIEF SUMMARY OF THE INVENTION

The present invention relates to both a process and a method of applying an applique to a substrate from a foil, and typically a metal foil. The foils may be any of a variety of foils, including, for example, pigmented foils, metallized foils, and the like. Indeed, the process of the invention, as well as the associated apparatus is also highly effective in applying a holographic foil applique to a substrate.

The invention is effective in that it allows for the application of a foil applique to numerous substrates, which was not previously available in the prior art. For example, the method of the invention and the associated apparatus is effective in applying a foil applique to very nonporous surfaces, such as glass surfaces, ceramic surfaces and metal surfaces. This has enabled the use of the process and apparatus of the invention to be effective in applying a foil applique to a surface of a coin, such as a currency coin. Moreover, by use of applying an applique to a coin, the possibility of theft or counterfeiting is reduced. In fact, the application of a holographic foil to a coin almost completely prevents the undetected counterfeiting of that coin.

In accordance with the present invention, a coating is initially applied to the substrate. The coating is applied either in combination with a hardener, or otherwise applied to a hardener which may be pre-applied to the surface of the substrate. However, intermixing of the hardener with the coating itself is preferred.

The coating is applied in such manner that it has a shape and size closely approximating that of the foil applique which is to be applied to the substrate. The coating itself may be slightly larger than, and does not necessarily have to critically follow the exact shape of the foil applique, inasmuch as the foil applique will only adhere to that portion of the substrate to which the coating has been applied. In other words, the foil applique actually adheres to the coating, and only the coating, as opposed to the substrate.

This process is highly effective for use with currency coins and other coins, as for example, collectible coins which are commemorative or medallion coins. Inasmuch as metallic coins have an irregular surface, the applique is applied both to the smooth flat underlying surface, as well as the ridges and grooves formed in that surface. In the prior art processes and apparatus, the foil applique was not tightly adherent to the underlying surface, and moreover, was readily susceptible to scratching or partial removal from the edges of ridges formed on that surface. The present invention, in contrast, by using the coating obtains a very tightly adherent and durable foil applique. Thus, the applique can be applied to surfaces which have both linear and nonlinear designs thereon.

The coating may be applied by any of a number of known techniques, including for example, hand painting, spray painting, electrostatic printing, other conventional printing techniques, or the like. Typically, conventional printing techniques have been effective in applying the coating to the substrate. The coating itself is preferably transparent, as for example, in the form of a non-color ink. In other words, the carrier for an ink with no pigment whatsoever can be applied to the surface of the substrate. As indicated previously, the foil applique is only adherent to the substrate in the area of the coating. Thus, if the coating was applied as the image of a head, then the foil applique would be applied precisely in that form.

The foil applique itself, can also be applied by conventional printing techniques. As also indicated previously, a hot foil application transfer system can be used, and a cold foil application transfer system can also be used. The hot foil or heat transfer system is preferred, since the foil applique becomes much more tightly adherent and durable. However, for certain articles, and depending upon the areas of use, the cold foil transfer technique is reasonably effective.

Nevertheless, regardless of the transfer system which is used, the applique can only be applied to that portion of the substrate having the coating thereon, since the applique will not tightly adhere to the substrate in regions where there is no coating.

The process and the apparatus used in the present invention will still be subject to some process variables. Thus, temperature, dwell times, and the like, will have to be adjusted for the particular substrate composition and substrate surface characteristics. Moreover, the hardener which can be used, is also to some extent dependent upon the type of substrate, and particularly, the composition of the coating.

The coating itself is frequently a urethane resin coating. However, other coatings, such as other urethane based coatings, acrylic based coatings, and epoxy based coatings, can also be employed.

The hardener which is used is effectively a cross-linking agent which allows a coating to essentially polymerize and harden on the surface of the substrate. The hardener selected is dependent upon the composition of the coating. Effective hardeners are those which can be used in glass and metal. Thus, isocyanate hardeners, and even some isothiocyanate, aliphatic, and like hardeners, can be used. Ethanol is also an effective hardener.

The same coatings which are used in a hot transfer system can also be used in a cold transfer system. However, the foil applique in the hot transfer system is only applied to a coating which has been fully hardened or cured. In contrast, in the cold application process, the foil applique is only applied to the coating while the same is in a partially cured stage, as for example, a so-called “B-stage”.

It is also possible to preheat the substrate or the coating composition, or both, in the hot transfer process. Preheating in the cold transfer process also is highly effective.

As indicated previously, the various process parameters differ depending upon the compositions of the substrate and the coating, as well as the surface characteristics of the substrate. These parameters usually are temperature, pressure and time, such as dwell time, that is, the amount of time that a platen or die remains in contact with the surface of the substrate.

Broadly, the process of the invention can be described as a process for applying an applique from an applique bearing foil, to a substrate which has a composition and/or surface characteristics not normally amendable to effective foil transfer. The process comprises applying a coating to an area of the substrate to which a foil applique is to be applied. Thereafter, the process comprises at least partially curing the coating. Finally, and in a broad sense, the process comprises transferring an applique from a foil through foil application transfer techniques, but only to the area of the substrate which has the coating thereon.

In another broad aspect of the invention, the invention can be described as a process for applying a foil applique having a holographic image thereon to a substrate. In this case, the process comprises applying a coating to the substrate to which the applique is to be applied, and thereafter applying to the coating on the substrate an applique which has a holographic image thereon.

The present invention also provides an apparatus for producing an article comprised of a substrate with a holographic image thereon, and which substrate has a composition and/or surface characteristics non-amendable to effective foil transfer. In this case, the apparatus comprises a means for applying a coating to an area of a substrate to which the foil applique is to be applied. In a preferred embodiment, this means for applying the coating comprises a pad printing means. The apparatus also comprises a means for at least partially curing the coating, such as a preheater, or the like. In addition, the apparatus comprises a means, as for example, a printing system, for applying an applique from a foil through foil application techniques, but only to the area of the substrate to which the coating has been applied.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus generally described the invention in general terms, reference will now be made to the accompanying drawings (four sheets) in which:

FIG. 1 is a perspective view of one form of printing apparatus for applying a foil coating to a substrate in accordance with the present invention, and which coating receives a foil applique;

FIG. 2 is a plan view taken substantially along the plane of line 2-2 of FIG. 1, and showing the area of a coating applied by printing techniques to a substrate in the nature of a coin;

FIG. 3 is a plan view, taken along the plane of line 3-3 of FIG. 1, and showing an area of a coating applied to a portion of the substrate of FIG. 1;

FIG. 4 is a side elevational view of the substrate of FIG. 3 with the coating thereon, taken substantially along the plane of line 4-4 of FIG. 3;

FIG. 5 is a schematic fragmentary perspective view, showing the application of a foil applique from a foil, through printing techniques, to a substrate;

FIG. 6 is a schematic view, showing a modified form of applying a coating to a substrate;

FIG. 7 is a side elevational view of a printing die assembly in a closed position, for applying a foil applique to a substrate;

FIG. 8 is a side elevational view of the substrate in FIGS. 5 and 7, and showing the coating and foil applique thereon;

FIG. 9 is a top plan view of the substrate of FIG. 8;

FIG. 10 is a schematic block diagram showing the steps forming part of the process in one embodiment of the present invention; and

FIG. 11 is a schematic block diagram, similar to FIG. 10, and showing the steps in a modified form of the process of the present invention.

### DETAILED DESCRIPTION OF A PREFERRED EMBODIMENT

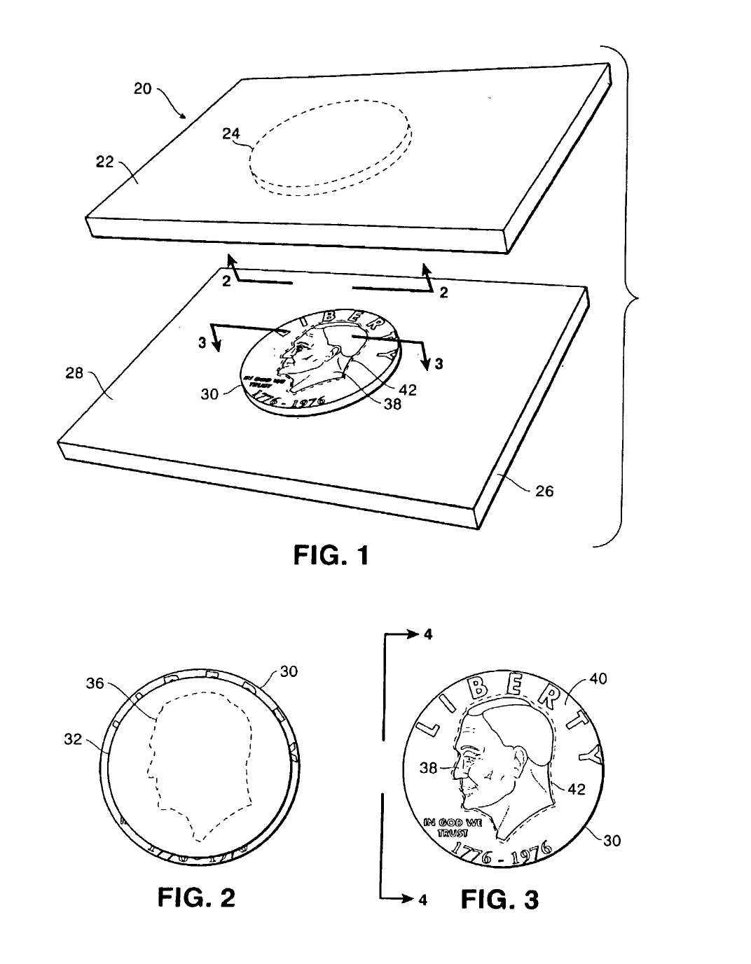

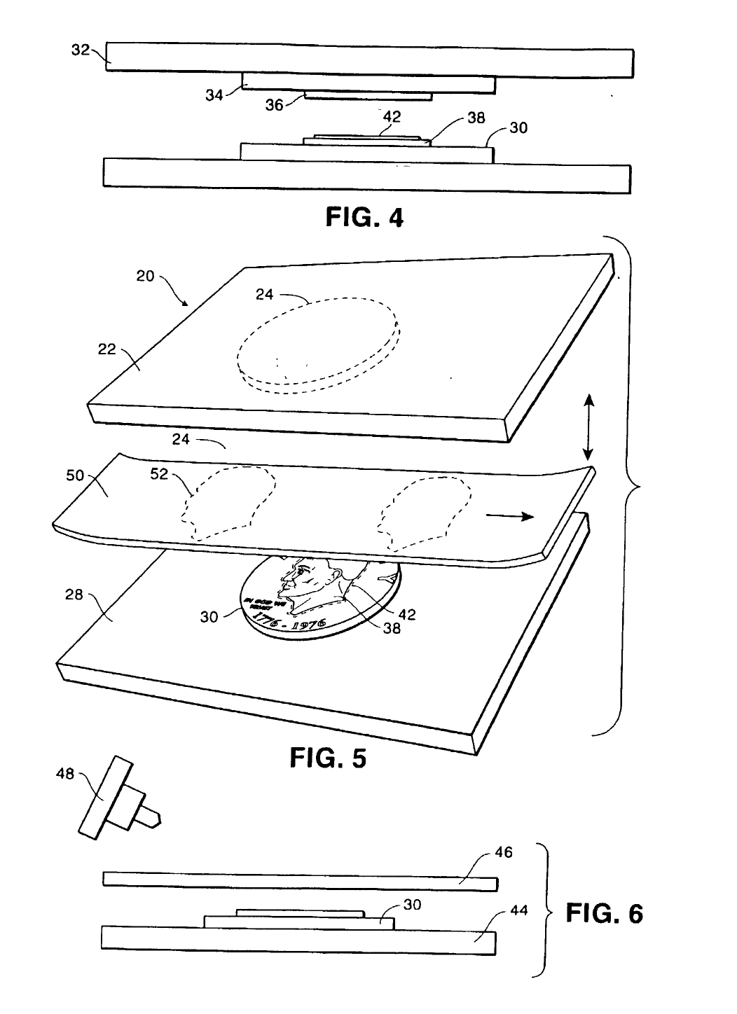

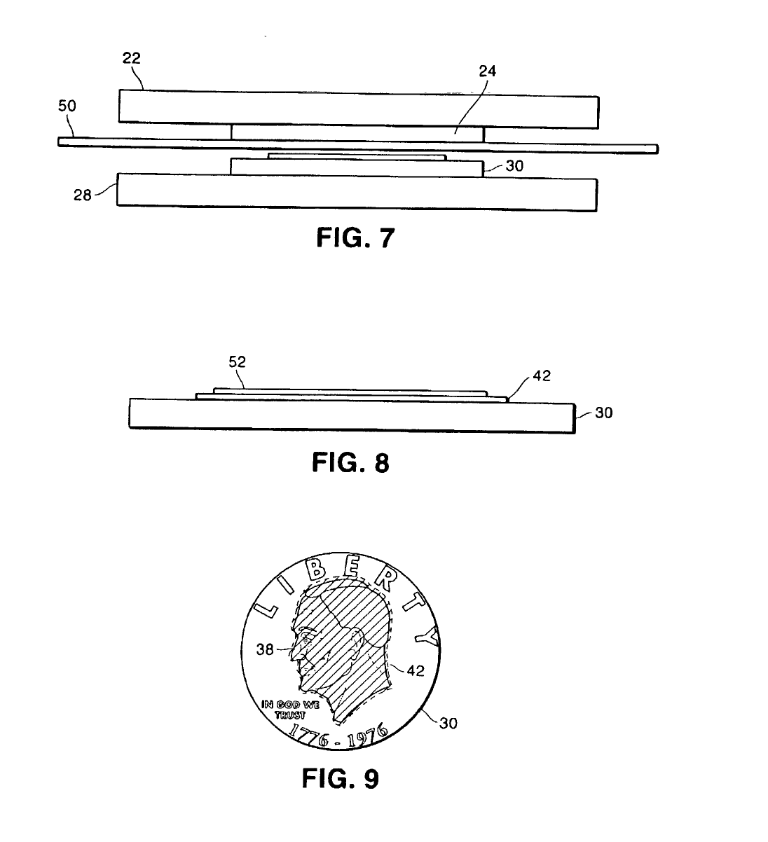

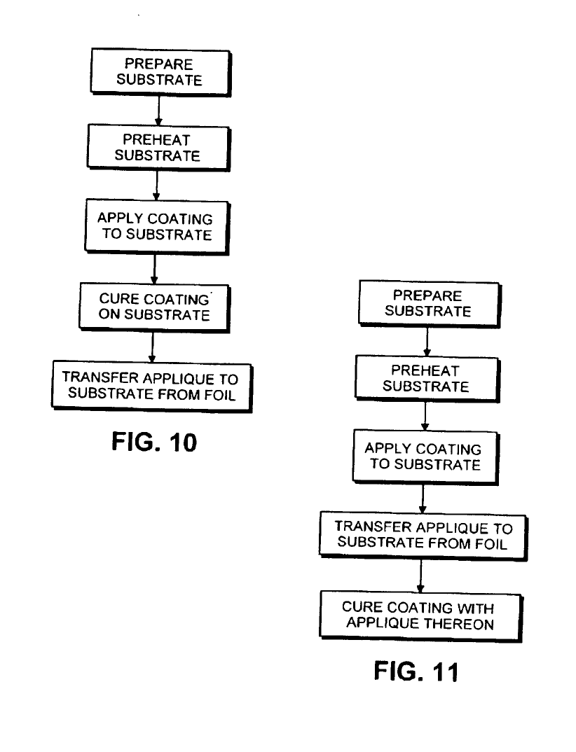

Referring now in more detail and by reference characters to the drawings, which illustrate practical embodiments of the present invention, these various drawings, comprised of FIGS. 1-9, in combination, show a system for applying a foil applique to a substrate. In this case, the substrate adopts a form of a coin, and typically, a metal coin which may be in the nature of a currency coin. However, it should be understood that while the invention is described in connection with the application of an applique to a coin, the invention is not so limited and can be used to apply a foil applique to essentially any substrate made of essentially any material.

One of the unique aspects of the present invention as previously described, is the fact that the applique can be applied to a substrate which may be highly porous or non-porous, that is, very dense, and which substrate may have a smooth surface thereon, or an irregular surface, or both.

Referring now to FIG. 1, it can be observed that there is a pad printing apparatus 20 having an upper platen 22 and a die plate 24 on its undersurface. The pad printing apparatus 20 also comprises a substrate retaining block 26 having an upper surface 28 for supporting a substrate 30, which in this case is a coin, as aforesaid. The overall size of the die plate 24 is essentially the same size as that of the coin, although it could be larger. The underside of the die plate 24, as best shown in FIG. 2, comprises a pad 32, such as a rubber paid, having a die surface 32 thereon. Moreover, this pad, if desired, can have a raised portion extending downwardly from the plane of a pad 32, such as a die face 36, and which may have a shape similar to that of the foil applique to be transferred.

Prior to the actual application of the coating and the foil transfer, it frequently is desirable to prepare the substrate for receiving the coating and the foil applique. In this case, cleaning of the substrate, possibly with a degreasing composition, may be employed. Depending on the type of substrate, some buffing may be required.

In the embodiment of the invention as shown in FIG. 1, it can be seen that the coin has an image of a head 38 thereon, and which may constitute a raised portion of the coin. Other portions of the coin may have a relatively flat surface 40, also as best shown in FIG. 3. In this case, and by reference to FIGS. 2 and 3, it can be seen that the rubber pad 32 has a die face 36, essentially corresponding to the overall shape of the head 38 on the coin 30. However, it can also be observed that the die face 36 is slightly larger than the head 38. A coating composition is then provided and applied to the upper surface of the substrate, such as the coin 30.

The coating composition may be applied to the substrate by initially applying the composition to the pad 32, and particularly, that portion of the pad having the outline of the head 36 thereon. However, other means for applying the coating could be employed in accordance with the present invention, as hereinafter described. However, when the coating is applied, it can be seen by reference to FIG. 3, that there is a coating layer 42 located over the head 38 on the coin, inasmuch as this is the region in which a foil applique is to be applied. Naturally, if a foil applique were to be applied to other regions of the substrate, those other regions would similarly have a coating thereon.

In one of the important aspects of the present invention it has been found that it is now possible to apply a foil applique to a surface having those characteristics and/or composition, which rendered it previously quite difficult, if not impossible, to apply a foil applique. Thus, by ensuring that there is a coating in the region in which the applique is to be applied, that applique can be applied to essentially any surface in a tightly adherent and durable manner.

In actual practice, the coating layer has a thickness, as hereinafter described, but an overall size and shape which is approximately equivalent to that of the image on the foil applique to be transferred to the substrate. Thus, and by reference to FIG. 3, it can be observed that the coating 42 has a shape substantially similar to that of the foil applique, although the area covered by the coating is slightly larger than that of the foil applique to be applied. Several techniques can be used to apply the coating in this manner, as hereinafter described. The first technique which can be used is that described in connection with FIGS. 1-3 of the drawings, in which a die 36 is literally formed on the rubber stamp pad 32. Again, that die can be of a relatively rough shape only approximately approaching that of the head 38 on the coin. However, and as indicated above, it is slightly larger than the head 38, to ensure that the applique is applied to a surface sufficient to receive the applique.

The coating composition is preferably applied in a range of about 1 mil. to about 5 mils. More preferably, the coating composition is applied in a thickness of about 2 to 3 mils. The actual coating composition will vary depending upon the substrate and the parameters used in the application process. As indicated previously, one of the preferred coating compositions is that of a urethane resin. However, as also stated, an acrylic base resin or an epoxy base resin may also be used. It is preferable to employ an ultraviolet based curing agent in order to provide some degree of ultraviolet protection to the coating.

The coating itself is preferably combined with a hardener. Several conventional hardeners may be used. The hardener may actually be applied to the substrate with the coating composition applied to the hardener. However, a more preferred embodiment employs a thorough mixing of the hardener with the coating composition. Some of the hardeners which can be used as effective cross linking agents include isocyanate and isothiocyanate hardeners, various know aliphatic low carbon chain hardeners, and for that matter, some aliphatic alcohols, such as ethanol. Other known hardeners can be used effectively. One effective combination of a resin and hardener is that offered by Visprox of Holland, under the designation TCP9901. The hardener for that particular resin offered by Visprox is available under the designation TCP9985.

The present invention provides a cold foil applique transfer and a hot foil applique transfer. In each case, the same coating composition can be used. Moreover, the same hardener can also be used in the cold foil transfer and the hot foil transfer. The use of a pad printing apparatus is effective for applying the coating since some of these apparatus also have the capability of applying both heat and pressure. Prior to the application of the coating, it may be desirable to preheat the substrate. Preheating can be easily accomplished by running the substrates under a bank of heating lamps, which would heat the temperature of the substrates to a range of, for example, 400° F. to about 520° F. However, the preheating temperature could vary for some systems from about 310° F. to about 650° F. The preheating is effective in enabling a fairly rapid cure of the coating composition and the hardener applied to the surface of the substrate, and moreover, facilitates the application of the coating to the substrate.

The use of the pad printing apparatus is also effective because the transfer die 24 has a surface formed of a relatively hard rubber. In this way, pressure is applied equally to the coating composition so that it will apply with uniform distribution across all portions of the surface of the substrate, regardless of the surface characteristics thereon. In effect, this hard rubber surface of the pad allows the pad to conform to the surface of the die face.

Although there are several means which may be used for applying the coating composition, FIG. 6 illustrates one such other means of applying the coating composition. In this case, a substrate, such as the substrate 30, is disposed on a work plate 44. The coating in liquid form is sprayed through a mask 46 from a spray device 48, as for example, a paint sprayer. In this way, the mask has opened areas which allows the coating composition to to impinge upon the surface of the substrate 30, essentially in conformance with the design of the foil applique to be applied to the substrate. Although this system is basically quite simple, it is nevertheless quite effective in the present invention.

After the coating has been applied, it is possible to then apply a foil applique to the substrate. It is important to recognize that foil appliques oftentimes will not effectively transfer to some substrates, and particularly, substrates having smooth metal surface areas through heat transfer techniques, and which are frequently referred to as “foil transfer”. Therefore, in accordance with the invention, a coating is applied to the substrate to allow the foil applique to be applied to the substrate, but only in the region where the foil transfer will adhere to the coating. If any portion of the substrate is applied to the substrate in a region where no coating has been applied, the foil applique will not readily adhere to the substrate.

The foil applique is applied with a printing apparatus, such as that pad printing apparatus 20, more fully illustrated in FIG. 1 of the drawings. In this case, and after the coating has been applied to the substrate, such as the coin 30, a foil is passed between the die 24 and the substrate 30, located on the platen 28. The foil, designated by reference number 50, is provided with at least one applique 52, which can be transferred to the substrate 30. In the embodiment as shown, a plurality of such identical appliques, or for that matter, different appliques 52, can be located on the foil for application to one or more individual substrates. When the upper platen 22 is shifted downwardly in the direction of the arrow, as shown in FIG. 5, it will engage the foil strip 50, and cause a foil applique 52 to be applied to the upper surface of the coated area 42, on the coin 30. As this occurs, the rubber pad on the undersurface of the die 24, will force the foil applique into adherence with the upper surface of the substrate 30. By reference to FIG. 8, it can be observed that the foil applique 52 is adhered to the upper surface of the coating 42, which has previously been deposited on the coin 30.

The pad printing apparatus 20 is only one type of apparatus which can be used for causing a transference of the foil applique 52, to the upper surface of the substrate 30. This device is effective in that the rubber pad on the underside of the die 24 will apply a uniform pressure to the upper surface of the foil, and hence, to the foil applique on the undersurface of the foil 50. Moreover, and due to the fact that the platen 28 can be heated, both heat and pressure are applied to the coin or to the foil applique, or both, during the transference process. This is highly effective in hot foil transfer. This heat and pressure will cause the foil applique to literally fuse to the surface of the substrate 30. The hot stamping technique as employed is quite effective, although its effectiveness is limited based on the size of the substrate. However, when the substrate has the size of the coin, this transfer process is highly effective.

The amount of pressure and, for that matter, the amount of heat which is applied can vary depending upon the composition of the coating and the particular foil applied, as well as the substrate. In either case, it may be desirable to preheat the substrate to a temperature of about 300° F. to about 650° F., and preferably, a temperature within the range of about 400° F. to about 520° F. Again, the duration of the preheating will vary depending upon the mass contained in the substrate. The preheating temperature is typically higher than the temperature used in a hot melt transfer. In this case, the hot melt transfer may be within a temperature range, of for example, 200° F. to 500° F. However, temperatures within the range of about 400° F. to about 475° F. are most effective for the hot melt transfer.

In many cases, depending upon the composition of the coating, as well as the composition of the metal, the temperature, and for that matter, the pressure, may vary. Also, the dwell time, that is, the amount of time pressure is applied or temperature is applied, will also vary. Insufficient temperature will cause low adherence of the foil applique to the substrate. Too high a temperature can also result in out-gassing as well as fusing of other portions of the foil (beyond the applique) to the substrate. Generally, pressure in the range of about 60 to 110 pounds is effective for glass, with a preferred pressure in the range of 80 to 90 pounds per square inch. For metal substrates, pressure may be in the range of about 80 to about 140 pounds per square inch, and preferably, 115 to 125 pounds per square inch. With flat metal substrates, pressure is preferably present in the range of about 60 to 120 pounds per square inch, and preferably in the range of about 80 to 90 pounds pre square inch. The dwell time can be relatively short, in the range of about one-half second to about one second. However, and as indicated previously, the dwell time certainly can be increased or decreased depending upon the foil transfer characteristics.

There is essentially no criticality to the thickness of the coating. However, it should have sufficient thickness to allow fusing of the applique to the surface of the substrate. The coating can be applied by any of a number of means, as for example, screen printing or pad printing, as previously described. Other techniques, such as selective liquid deposition, spray painting, or painting through masks, can be employed. The coating should be at least 2 to 3 mils., again depending upon the porosity of the substrate. In the cold transfer system, preheating may be applied, if desired. However, heating generally does not occur during the foil application step. The coating should be at least ninety percent cured for a cold transfer, and also in a C-stage, which in this case, can be as much as ninety percent cured. The cold transfer is effective due to the fact that the coating operates as an adhesive in cold transfer. It is not necessarily as durable as a hot melt transfer, although it can be effective.

In the cold applique transfer technique, the foil will typically have a thickness ranging from 1 to 10 mils., and preferably, a relatively thin thickness ranging between 1 to 2 mils. However, the coating thickness can range from about 0.5 mils to about 10.0 mils.

Thus, there has been illustrated and described a unique and novel applique transfer system which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1 A process for applying an applique from an applique bearing foil to a substrate which has a composition and/or surface characteristics not normally amenable to effective foil applique transfer, said process comprising:
a) applying a coating to an area of a substrate to which a foil applique is to be applied;
b) at least partially curing the coating; and
c) transferring an applique from a foil through foil applique transfer techniques to only the area of the substrate which has the coating thereon.

2 The process of applying an applique of claim 1 further characterized in that said process comprises preheating the substrate before application of a coating thereto.

3 The process of applying an applique of claim 1 further characterized in that the process comprises partially curing the coating and applying the foil applique to the partially cured coating.

4 The process of applying an applique of claim 1 further characterized in that the process comprises fully curing the coating and then applying the foil applique to the fully cured coating.

5 The process of applying an applique of claim 1 further characterized in that the process comprises applying the applique to a substrate selected from the class consisting of glass, ceramics and metal.

6 The process of applying an applique of claim 1 further characterized in that the process comprises applying the coating in such manner that a hardener for said coating aids in curing of said coating or said substrate.

7 The process of applying an applique of claim 1 further characterized in that said process comprises preheating the substrate prior to application of a coating thereto and heating the substrate with pressure after the coating has been applied thereto, and the temperature of the preheating is higher than the temperature used for curing the coating.

8 The process of applying an applique of claim 1 further characterized in that the process comprises applying to the substrate said coating in a thickness ranging between 1-5 mils.

9 The process of applying an applique of claim 1 further characterized in that the process comprises applying to the substrate said coating in a thickness ranging between 2-3 mils.

10 The process of applying an applique of claim 1 further characterized in that the process comprises applying to the substrate and coating thereon a foil applique which has a holographic image thereon.

11 A method for applying a foil applique having a holographic image thereon to a substrate, said process comprising:
a) applying a coating to an area of said substrate to which the applique is to be applied; and
b) applying to the coating on the substrate an applique having a holographic image thereon.

12 The process of applying an applique of claim 11 further characterized in that said process comprises applying the coating and applique to a currency coin.

13 The process of applying an applique of claim 11 further characterized in that said process comprises preheating the substrate before application of a coating thereto.

14 A process of applying a foil applique to a metal substrate of the type having surface characteristics or composition not readily receptive to having an applique permanently applied to the substrate, said method comprising:
a) applying to a surface of a substrate a coating which is compatible with the substrate and which coating is especially adapted to receive a foil applique applied thereto and allows for a permanent adherence to the substrate; and
b) applying to the coating on the substrate a foil applique in the region where the coating was applied.

15 The process of claim 14 further characterized in that the method comprises applying a coating having a size and shape closely approximating the size and shape of the applique to be applied to the coating, and applying that applique to the coating such that the need for marginal registration is eliminated.

16 The process of applying an applique of claim 15 further characterized in that said process comprises preheating the substrate before application of a coating thereto.

17 The process of applying an applique of claim 15 further characterized in that the process comprises applying to the substrate and coating thereon a foil applique which has a holographic image thereon.

18 An apparatus for applying an applique from an applique bearing foil to a substrate and which substrate has a composition and/or surface characteristics non-amendable to effective foil transfer, said apparatus comprising:
a) means for applying a coating to an area of a substrate to which a foil applique is to be applied;
b) means receiving the substrate with the coating thereon for at least partially curing the coating while on the substrate; and
c) transferring an applique from a foil only to the area of the substrate which has the coating thereon.

19 The apparatus of claim 18 further characterized in that the coating is applied by pad printing techniques.

20 The apparatus of claim 18 further characterized in that the coating is applied by spraying through a mask having an outline of the image which is to be applied with foil transfer.
The apparatus of claim 18 further characterized in that the means for applying an applique is a printing apparatus which engages and causes the applique while on the foil to be brought into contact with the coating on the substrate.

22 The apparatus of claim 18 further characterized in that the apparatus comprises means for curing the coating on the substrate.

23 The apparatus of claim 18 further characterized in that the coating is applied in a thickness range of between 1-5 mils.

24 The apparatus of claim 18 further characterized in that the coating is applied to the substrate in a thickness ranging between 2-3 mils.

25 The apparatus of claim 18 further characterized in that the means for applying the foil applique comprises means to apply an applique having a holographic image thereon.
